(19) United States
(12) Patent Application Publication
(10) Pub. No.: US 2002/0178370 A1
(43) Pub. Date: Nov. 28, 2002

(54) Method and apparatus for secure authentication and sensitive data management

(76) Inventors: Michael N. Gurevich, Walnut Creek, CA (US); Vit Kantor, Arlington Heights, IL (US)

Correspondence Address: Michael J. Mallie, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/751,596

(22) Filed: Dec. 29, 2000

Related U.S. Application Data
(60) Provisional application No. 60/173,731, filed on Dec. 30, 1999.

(51) Int. Cl. H04L 9/00

(52) U.S. Cl. 713/189; 713/184; 380/277

(57) ABSTRACT

A method and apparatus for improved data management are described. In one embodiment, the method comprises generating a first key component, generating an encryption key using the first key component, a token key and a personal identification number (PIN), encrypting data using the encryption key, and sending the data encrypted with the encryption key to a server along with the first key component.

This application claims the benefit of U.S. Provisional Application No. 60,173,731 entitled “A Method and Apparatus for Secure Authentication and Authentication Management,” filed Dec. 30, 1999.

### FIELD OF THE INVENTION

The present invention relates to the field of data management in systems; more particularly, the present invention relates to secure data management in a networked environment.

### BACKGROUND OF THE INVENTION

Typical computer user nowadays deals with a variety of secure services such as web sites, email services, dial-up accounts, application programs, etc. To get access to a secure service a user has to pass authentication—a process by which the user (subject) provides his name (identity) and password or other authentication data to a mutually trusted entity (principal authenticator). The principal authenticator (traditionally embedded into the secure service itself or, more advantageously, a separate entity) is responsible for granting/denying access (a communication link and access privileges) to the subject. While good encryption techniques exist to prevent tapping on communication links to such services, there are no good methods from preventing passwords or other authentication data themselves from being guessed or stolen. A number of password cracking programs exist and they are very effective in guessing passwords by combining dictionary search and basic human engineering techniques. A really good password shall be as long as possible and absolutely devoid of any semantic meaning. A good practice is to change passwords periodically. Many existing secure services enforce periodic change of passwords and, additionally, disallow re-using of old passwords. However, people are unable not only to create good passwords, but most importantly, to remember them. Thus, robust, hard to guess passwords must be written down somewhere. Also, entering them is a nuisance.

Quite often a user has to access password-protected services from computers different than that user's “primary” computer. Although, having different passwords for each service makes perfect sense, it is difficult to accomplish this without some access management utility that frees the user from the necessity to invent, remember and type all these different passwords. Furthermore, there should be a way to detect and block unauthorized use of such access management utility. For the authorized user, there should be a way to restore his/her passwords preventing, at the same time, unauthorized use by an illegitimate user.

Corporations need a reliable and inexpensive way to manage restricted access to its resources, including mechanisms to supply their employees and customers with a secure and easily manageable password distribution and protection mechanism.

Both individual users and corporations are often interested in keeping track of what particular secure services were accessed by a particular user and an indication of when those services were accessed. Besides passwords, a user may need to handle other types of data that should be kept in confidence. This data includes, but is not limited to: personal profile data (e.g., social security, driver license numbers, addresses, etc); payment instruments and financial data (e.g., accounts and credit/debit card numbers, etc.); Public Key Infrastructure (PKI) credentials including public keys, private keys and/or digital certificates, and other types of cryptographic data; other types of data used for authentication, (e.g., biometric profiles, etc.); online forms with arbitrary content that user fills in using an internet browser on a wired or wireless Internet-enabled device; and arbitrary data (e.g, data files). As described herein, the term “user” means both human users and/or software applications that require access to sensitive data (e.g., an application may need to use a set of PKI credentials or to supply a password to login to a database, etc.).

There are a number of common problems related to managing sensitive data of any nature. For example, one common problem is dependable and convenient handling of sensitive data. That is, protecting data from any unauthorized use that includes ensuring that a transaction involving sensitive data has been originated by the data's true owner. A good example is ensuring that an online purchase using a credit card has been initiated by that card's true owner. The data must be well-protected against user impersonation and forceful break-ins. Convenience means that human user should be relieved from repetitive operations; a user should be guided by the system as much as possible. Another problem is creating data of high quality. For instance, user passwords should be hard to guess.

Still other problems include data distribution, revocation, and validity checking, and accessing data in a mobile and portable manner. Mobility and portability mean that the system allows a user to manage his sensitive data using a variety of wired and wireless devices and allow a user to preserve his digital identity independently on what device he is using at a particular moment.

PKI is surely becoming a preferred mechanism for implementing sensitive transactions protection and non-repudiation. There is a number of specific problems that significantly slow down wide-spread PKI adoption, both in wired and wireless environments. For example, PKI mobility and portability: a user should be able to access his PKI credentials from any device, including wireless and personal computers (PCs) not belonging to the user. PKI credentials are usually stored in an encrypted profile on user's PC, and there is no way of allowing users to carry their PKI profiles with them. As different institutions (banks, brokerages, etc.) start implementing their own PKI deployments, the users are required to carry around multiple sets of PKI credentials.

Another problem is that PKI profiles stored on users' computers are vulnerable to off-line guessing attacks. Also problematic is that PKI credentials management, including distribution, revocation, renewal is very difficult to handle in large deployments. Time for new credentials distribution becomes comparable with the key lifetime itself. Distributing renewed credentials to users that possibly do not even use them, or use them infrequently, is a costly and time-consuming process.

PKI problems are even more severe in the wireless environments. Wireless devices and network constraints are not allowed to keep multiple PKI credentials on the wireless devices themselves (and even keeping one certificate on a device is often unfeasible). Sending signed messages with certificates attached via wireless networks consumes a lot of resources and may be not viable at all.

An additional problem is the data vulnerability window on the wireless gateway. Specifically, data travels wireless network encrypted under WTLS protocol. On the wired leg of the data route, data is encrypted under the SSL protocol. On the wireless gateway, the data is decrypted and re-encrypted (WTLS to SSL or vice versa), thus there is a time period during which the data is not encrypted on the gateway.

Hardware authentication assistant devices (SecureId from RSA Technologies of Bedford, Mass., Digipass from VASCO) are used for accessing secure services. The user must physically posses the SecureId device in order to access the service. Although these SecureId devices provide good mechanism for preventing unauthorized access to a company's Intranets, these tokens do not solve the problems described above. Users still need to remember and maintain their passwords.

Software authentication assistant utilities (NetConcierge from NextCard Inc.) provide a mechanism for “remembering user's authentication data” and assisting the entering of this data during a “next session”. These utilities do not solve problems discussed above.

Digital certificates deploy a notion of a “mutually trusted third party” for accessing secure services. A digital certificate is obtained by the user from the “mutually trusted third party” and is used by a cooperative secure server (especially designed) for checking with the “mutually trusted third party” if the user is authorized for requested service. However, these certificates are usually stored on the user's computer, and thus, are accessible by everyone who has access to that computer. Digital certificates do not solve the problem of reliable and restricted management of restricted users needed by corporations. Moreover, the use of digital certificates is limited to “cooperative” secure services.

On-line aggregation and e-wallet services such as, Yodlee and Obongo, deal only with users' logon data (user Ids and passwords) and with online forms in a limited fashion (filling in only user profile-related data). These solutions have various security deficiencies, such as lack of strong authentication and data vulnerability windows.

More secure PKI management solutions from PKI vendors (e.g., Entrust Technologies of Ottawa, Canada, Baltimore Technologies of Dublin, Ireland, Verisign of Mountain View, Calif.) are narrowly oriented to deal with PKI data only and do not solve all problems described above.

### SUMMARY OF THE INVENTION

A method and apparatus for improved data management are described. In one embodiment, the method comprises generating a first key component, generating an encryption key using the first key component, a token key and a personal identification number (PIN), encrypting data using the encryption key, and sending the data encrypted with the encryption key to a server along with the first key component.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates user authentication and data storing/retrieval mechanism in which three components, a token, PIN and server, are included in order to access the data.

FIG. 2 illustrates how the system deals with online forms for both on wired and wireless devices.

FIG. 3 illustrates one embodiment of a process of using PKI credentials.

FIG. 4 illustrates the method described above for handling signed transactions on wireless devices.

FIG. 5 is a block diagram of one embodiment of a computer system.

### DETAILED DESCRIPTION OF THE PRESENT INVENTION

In the following description, numerous details are set forth, to provide a thorough understanding of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Overview

Methods and apparatus for secure authentication and sensitive data management are described herein. In one embodiment, a server operated by a service provider and individualized secure tokens (tokens) are used to facilitate the secure authentication and sensitive data management. The tokens may be hardware and/or software and are distributed to the users (subscribers). Sensitive data is stored on the server. In one embodiment, each item is individually encrypted with a unique just in time generated encryption key, where “just in time” refers to the fact that the encryption key is generated only when it is to be used and not in advance. These encryption keys are not stored anywhere and are re-created on the fly when needed. To access sensitive data, the client software (in case of a hardware token residing on it) utilizes data located on the token, and on the server, and in the subscriber's head.

In one embodiment, the token is preferably a credit card-size CD-ROM disk or a conventional CD-ROM disk. The card-size CD-ROM disk is a preferred because of its physical dimensions. Credit card-size CD-ROM disks currently offered in the market are readable by a conventional CD-ROM driver and provide capacity of about 22 MB of data. In another embodiment, the token is a general-purpose palm held computing device. In yet another embodiment, the token is a digital phone. In still another embodiment, the token is a smart card. Token may also be implemented entirely in software.

Passwords are one of the sensitive data types the system described herein manages. The system provides for just in time, high quality passwords generation and allows a user to specify password characteristics, such as, for example, maximum length, allowed symbols, etc. High quality passwords (the ones that are very difficult to crack) are rarely used because people have very hard time remembering and typing them in, but the system described herein relieves users from the necessity to remember and manually input their passwords. “High quality” passwords are the ones that are extremely hard to guess. Thus, they should be devoid of any semantics (such as, for example, “your wife's maiden name plus your dog's name”, etc.) These semantically meaningless passwords should, in addition, be composed of a mixture of lower- and upper-case letters, digits, and special symbols.

If an on-line form contains a password (used to login to a website, for instance), a client-side application (referred below as PMU or SDMU) recognizes that and allows for automatic generation of that password. instead of using a human-invented password. The client-side application may recognize if an on-line form contains a password by acquiring access to the content of a downloaded page. The automatic generation of a password may be performed, for instance, by choosing symbols for the passwords randomly and ensuring that these symbols are combined according to a “high quality password rules” described above. Password generation may also be triggered explicitly by the user. Besides this password-generation feature, the system treats logon forms the same way as any other on-line form.

Password-only Management System.

In one embodiment, for the purpose of handling a subset of sensitive data that includes only passwords, a token contains: a password management utility program (PMU); a randomly generated very long stream of bytes(VLSB); optionally, a unique Subscriber Personal Identification Number (PIN); optionally, additional content for advertisements, products promotions, etc., may be included. The PMU manages all aspects of token use, including most importantly just in time password generation and prevention of unauthorized use. Preferably, the PMU complies with traditional communication security such as, for example, the secure handshake with the server and message encryption. The PMU is preferably a Java application, thus providing for multi-platform support.

In one embodiment, the VLSB is 15-20 MB long. In one embodiment, the VLSB is subscriber specific and is stored and/or written on the individualized token. In another embodiment, the VLSB is generated by a device or system, such as, for example, a personal palm held computing device. This stream of bytes is used for password generation.

In one embodiment, the PIN is encrypted by the server's public key and is stored on the token itself. For additional security, a subscriber may request from the server his own PIN and provide this PIN to the PMU upon program startup. Either stored on the token or provided by the subscriber, the PIN (preferably encrypted by the server's public key) is used to identify the individual token to the server.

In one embodiment, in the case of such a system that only handles passwords, the server is an application running on a service provider's host. In one embodiment, the server provides (in conjunction with PMU) for: tokens identification; service activation/deactivation; usage tracking; enabling PMU for just in time password generation; and prevention of unauthorized use based on usage tracking.

Password Management Utility

In one embodiment, the PMU is implemented as follows. When a subscriber needs a password for a given service (service name) for the first time, the user provides to the PMU, the service name and user identity to the service (Subject Id). The subject ID refers to a combination of a service name that requires the password and the user login name for that service. For instance, if a user has an account with a Yahoo Mail with login name “Smith135”, then the subject ID would be “Yahoo Mail-Smith135”. Firstly, the PMU randomly generates a string of bytes, referred to herein as the seed key. Second, the PMU generates on the fly a password for the service by using the seed key to control which bytes of the VLSB in the token to use for the password. The PMU can take into account subscriber-provided password characteristics such as, for example, password length, specification whether special symbols are allowed in the password, etc. Third, the PMU saves the association <“service name”-“subject Id”-“seed key”-“password characteristics”> (access entry) on the local computer and on the server (if the computer is connected to the Internet). For instance, an access entry for User's Yahoo email account could be: <Yahoo Mail-Smith135-sI(5 gb#j-“length-10, alpha-numeric symbols only”>. Preferably, this access entry is encrypted. In one embodiment the encryption key is generated by the same algorithm as for the “just in time password generation” but using the token's PIN as the “seed key”.

Fourth, in one embodiment, the PMU copies the generated password to the clipboard from where the subscriber may paste it to the authentication window. In another embodiment, the PMU advantageously copies the subject Id and the generated password directly to the authentication window where a user is supposed to enter his login name and password of the service.

When the subscriber accesses that service again, the PMU uses a previously created access entry for that service and regenerates the password on the fly. In one embodiment, the user identifies the service name to the PMU. In another embodiment, the PMU advantageously identifies recurring access to the secure service automatically (by URL or other means).

One benefit of this mechanism of just in time password generation is that no passwords are stored neither on the server, nor on the subscriber's computer. The passwords are re-generated as they are needed. Another benefit is that no passwords are transmitted between the server and the subscriber's computer. To reproduce the password, both a unique token and a seed key for the password service are required. In one embodiment, the seed keys are stored in encrypted form. In one embodiment, the passwords are extremely hard to guess because of a very long stream of bytes used to generate them, the passwords have the maximum length allowed and passwords are semantically meaningless. The maximum length allowed may be used, but is not necessary. However, the longer the password, the more difficult it is to crack. Different services and/or application have different restrictions on how long the password may be.

In one embodiment, in the case of a passwords handling-only oriented system, the server is implemented as follows. First, the PMU connects to the server over the Internet using a secure connection method (such as, for example, SSL) and transmits the unique PIN to the server. The PIN is preferably encrypted by the server public key. Next, the server verifies that the token with that PIN has not been reported as stolen or lost. If the token has been compromised, the server breaks the connection with the PMU and records the IP address of the PMU. This IP address may be used to track down the perpetrator.

Else, if token's legitimacy has been confirmed, the server sends back to the PMU a list of access entries for all previously accessed secure services. In one embodiment, the list is preferably encrypted by the SSL session key. Thereafter, the PMU saves the list on the local computer. Each access entry of the list is preferably saved individually encrypted as described herein. This will advantageously enable the PMU for adding/deleting/updating new access entries to the list without re-encrypting of the whole list. Next, each time the PMU generates a password, it creates a usage entry minimally consisting of association <“service name”-“time stamp”>. Afterward, each time a new usage entry is generated, or periodically, all new usage entries are sent to the server. This advantageously enables the server for usage tracking.

If a subscriber loses the tokens, or if it is stolen, he/she reports the fact to the server and the token is marked as compromised. The PIN may be marked as compromised. In one embodiment, in this case, the subscriber may be issued two tokens—an “old” token, with the PIN and VLSB as the lost one, and a “new” token, with a new unique PIN and VLSB. The new token enables the server to send to the subscriber the same list of access entries as was accumulated through the usage of the stolen token. However, all these access entries are marked as requiring a change in the password. For each access entry in the list, the PMU requests the subscriber to access the secure service by using the “old” token and to generate a new password by using the “new” token. Each time the server receives a usage entry, it clears the mark requiring password change for the corresponding access entry.

In another embodiment, a subscriber may be issued a new token with the same VLSB and unique new PIN. In that case, no passwords regeneration is required, and at the same time, use of the old token is blocked (because its PIN is reported as compromised).

In one embodiment, the content of tokens (PIN and VLSB) issued to subscribers is stored securely at the manufacturing facility of the token. In another embodiment, the manufacturing facility may have a mechanism to re-generate the VLSB using the token's PIN. In either case, the content of tokens is not accessible through Internet.

In one embodiment, a subscriber may choose not to store the content at all, but in that case he/she has to change his/her passwords for all his/her password-protected services.

In one embodiment, a subscriber may order multiple copies of the token with all copies having the same VLSB and a unique PIN.

This process of token use described above provides for confirming the token's legitimacy every time the token is used, disabling the token if it is lost, or stolen, or compromised in some other way, and restoring the use of the token to a subscriber without recreating all the passwords that subscriber uses. At the same time, there is no risk that a compromised token may be used by an unauthorized entity. Optionally, the process of token use may allow for detailed tracking of the token use.

Generic Sensitive Data Types Management System

In one embodiment, for the purpose of handling sensitive data of multiple types, including arbitrary online forms, PKI credentials, etc., a token contains: a Sensitive Data Management Utility program (SDMU); a unique per token information for constructing a subscriber's digital identity; and optionally, additional content for advertisements, products promotions, etc.

The SDMU manages aspects of token use, including just in time encryption keys generation, user authentication and prevention of unauthorized use. In one embodiment, the SDMU complies with traditional communication security, such as, for example, secure handshake with the server and message encryption.

In one embodiment, the unique per token information comprises of a token ID represented as an alpha-numeric string and a token key represented as a very long randomly generated stream of bytes (preferably longer than 15M-20M) or number (preferably longer than 1K). The token ID is used to identify an individual token to the server. The token key, together with other components discussed below, is used to construct authentication messages and to generate and re-create in a “just in time” fashion unique per sensitive data item encryption keys.

In one embodiment, the server is an application running on a service provider's host. The server provides (in conjunction with SDMU) for: tokens identification and users authentication; service activation/deactivation; storing and retrieving individually encrypted sensitive data items; enabling the SDMU for just in time unique encryption keys generation; preventing unauthorized use based on usage tracking; and optionally, integrating with third-party applications.

In one embodiment, the following components contribute to a unique per user digital identity: a unique (per user) token ID and token key, and PIN—an alpha-numeric password that is associated with a token upon that token's initialization. The PIN may be either devised by a user or generated by the system for a user. A user may supply the PIN for authentication,. Alternatively, the PIN may be supplied as the result of biometrics verification. A user's digital identity is constructed by an application of a special operation to a combination of contributing items. In one embodiment, that special operation may be a one-way function (hash-function) such that it is computationally unfeasible to deduce the function's arguments from the result of that function application.

In an alternate embodiment, the PIN/token key combination may be substituted or augmented by biometric data, such as fingerprint, voice print, eye iris print, hands or face geometry, handwriting signature, etc.—depending on the type of biometric support available on the device in user's possession.

A user may possess multiple tokens of the same or different types, for instance, a credit card-size CD-ROM, a Windows CE-based palm hand-held computer, a Palm Pilot hand-held computer, a smart card and a Wireless Access Protocol (WAP)-enabled cellular phone. In that case, the system provides a mechanism to provision these devices with the same digital identity components, thus allowing a user to manage his sensitive data with every token he has.

In one embodiment, this provisioning may be done in the following way. First, a CD-ROM token contains special utility programs that put digital identity components (Token ID and Toke Key) and a device-specific SDMU on a specific token. A user has to connect a wireless device (token) to a PC via interfaces that the devices' manufacturers provide for the synchronization of the device with the PC. Device-specific SDMUs may be either supplied on the CD-ROM token, downloaded over the Internet, or provided another way well-known in the art. The utility programs load specific devices with an applicable SDMU and the same digital identity components as on the CD-ROM token. If the user does not have a CD-ROM token, the token ID may be supplied by the system over the Internet together with a device-specific SDMU, and a token key is generated in-place, on the user's PC, and placed on that users' devices (tokens).

The SDMU functionality preferably comprises user authentication, sensitive data items handling, sensitive data items encryption/decryption, storing/retrieving the data from the server, and cooperation with third-party applications that serve as sensitive data producers/consumers.

In one embodiment, the SDMU is implemented as follows. Upon a start up, and optionally at user-controlled intervals, the SDMU authenticates with the server. In one embodiment, to perform the authentication, the SDMU requests a user to enter his PIN, reconstructs a user's digital identity as described above and sends it to the server, preferably over a secure connection. The server matches the data it receives with the digital identity data stored on the server for that token (user). The manner in which the digital identity is constructed does not allow to learn the components contributed to its construction from the digital identity itself. That is, components that contribute to a user's digital identity are: a token key and a PIN. It is constructed by the SDMU every time authentication is required. By looking on the construction result, it is impossible to learn of what the token key and PIN are constructed.

As part of the authentication process, the server verifies that the token with a particular token ID has not been reported as stolen or lost. If the token has been compromised, the server breaks the connection with the SDMU and records the IP address of the SDMU. This IP address may be used to track down the perpetrator.

In one embodiment, the SDMU may operate in two modes simultaneously. It may be directed explicitly by the user to handle a particular sensitive data item. For some types of sensitive data, the SDMU may automatically monitor multiple applications producing and/or consuming of data of that type and handle this data in automatic or semi-automatic fashion with a reduced level of user intervention. The term “automatic” means that an application interacts with the SDMU without user intervention and sends/receives the data via the SDMU, while “semi-automatic” means that a user has to give a confirmation for the data to be transferred between the SDMU and an application.

Data handling involves both data type-specific operations and generic ones. Generic operations include generation and on demand recreation of unique encryption keys, encrypting/decrypting data and storing/retrieving of data from the server.

In one embodiment, when a particular data item has to be stored on the server, the SDMU performs the following. First, the SDMU assigns an identification (ID) to that data item and generates a random number referred to herein as the server key part-SKP (the server side key component). Then, the SDMU constructs a key base by applying a special operation, such as, for example, a one-way function (e.g., hash-function), to a combination of the token key, PIN, and SKP. The key base is used to produce an encryption key for a symmetric encryption algorithm of choice, such as, for example, Triple DES, Rijndael, Blowfish, etc. Next, the data item is encrypted with the created encryption key. Fourth, the encrypted data and not-encrypted SKP and data item identification are transmitted to the server, preferably over a secure connection. The server creates a data entry in a database containing a not encrypted data item identification and SKP and an encrypted data item content.

The data item identification is constructed in such a way that it may be re-created upon dealing with that data item again. The specifics may depend on the data item type. For instance, in case of an on-line form, the identification may be a combination of web page URL, form name, etc. In case of PKI credentials or arbitrary data, the identification may be explicitly assigned by user.

When the data item has to be retrieved from the server, the SDMU does the following. First, the SDMU sends to the server data item identification that the server uses to locate the data entry for this item in the database. The server sends the SKP and encrypted data item content to the SDMU, preferably over a secure connection. Next, the SDMU re-creates an encryption key for this data item. The SDMU does it the same way as when it constructs the key for encryption, but, instead of generating an SKP, it uses the one it got from the server. Thereafter, the SDMU uses that encryption key to decrypt the data.

In one embodiment, the SDMU converts the data in an XML format that describes data type characteristics as well as individual data item content. This XML-based representation is then encrypted and stored on the server in the way described above.

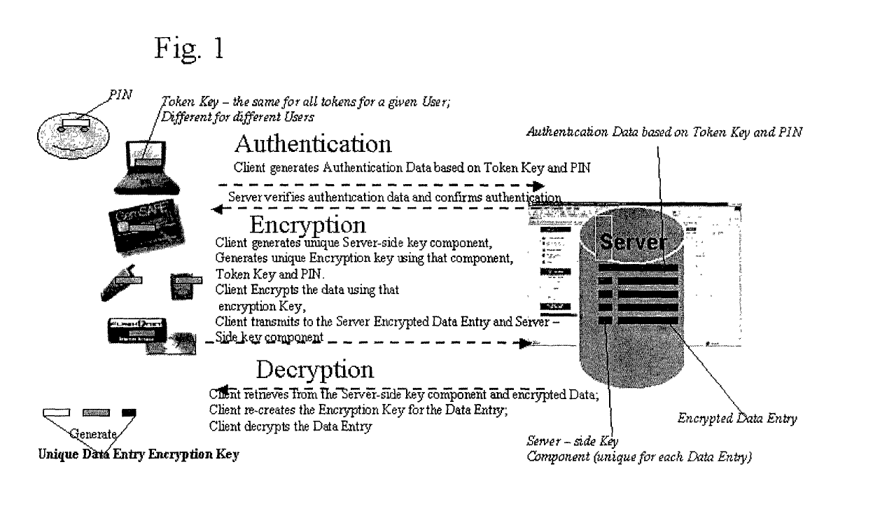

FIG. 1 illustrates user authentication and data storing/retrieval mechanism in which three components, a token, PIN and server, are included in order to access the data.

In one embodiment, a user may access a list of his data items through a SDMU interface and edit both the content of data items and the list itself. Content editing of a data item is data type-specific. List editing may include data item replication, disabling, re-enabling, deletion, etc.

In one embodiment, a data item is retrieved from the server and then re-encrypted and stored on the server every time it is accessed by the user. In an alternate embodiment, a number of data items may be retrieved in a bulk operation and kept encrypted on the client's computer to reduce network traffic.

In one embodiment, the SDMU may verify (in conjunction with the server) whether it is to be updated. If an update is to be done, necessary executables and libraries are downloaded from the server over preferably a secure connection, their authenticity confirmed (using Authenticode or similar techniques) and these updated executables and libraries are put to use.

In one embodiment, a user may direct the SDMU to load its executables and libraries to a local computer and run them from that location instead of a token. That may provide an added convenience when a user is working on a computer he frequently uses. In that case, the digital identity components are still accessible on the token. In alternate embodiment, a user may direct the SDMU to transfer digital identity components to a local computer also. In that case, the use of token is not required when working on that computer.

Data Types-specific Functionality

In one embodiment, the SDMU monitors a user's Internet browsing activities, automatically identifies that a web page contains form(s) and automatically or semi-automatically saves the data for new forms and/or retrieves the data for the forms already known to the system. Semiautomatic mode requires user's confirmation, while automatic mode does not. In one embodiment, the content of forms is converted to an XML document before encrypting it and sending it to the server. In one embodiment, the SDMU handles multiple forms per page and multiple variants of content for a given form.

If the form is not known to the system yet, it still may be partially (or even completely) filled if the SDMU identifies that the form contains data belonging to a user's profile (e.g., addresses, phone numbers, etc.). In that case, the SDMU presents a user with his profile data suitable for some fields in the form, and the user may fill in these fields with one click and the rest of the fields manually.

In one embodiment, a user may access a list of all forms (or some portion thereof) the system has already remembered for him and edit content of the forms on that list directly using the SDMU facilities. The SDMU may present a list of these data to a user in a special window. The results of this editing are preserved on the server in the same manner as if the user has edited a form in the browser window.

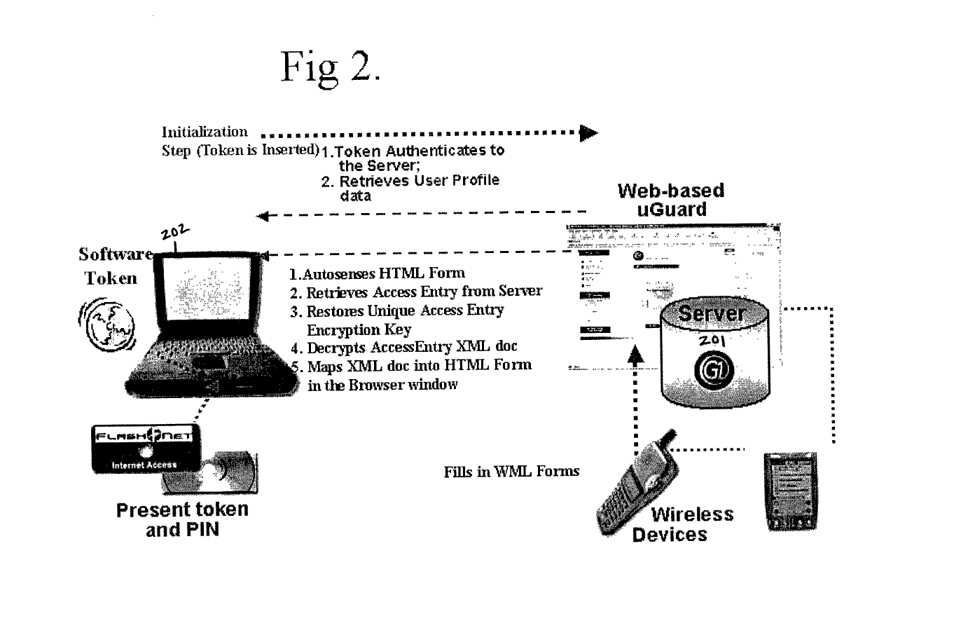

FIG. 2 illustrates how the system deals with online forms for both on wired and wireless devices. The operations are performed by processing logic that may comprise hardware (e.g., dedicated logic, circuitry, etc.), software (such as run on a general purpose computer system or a dedicated machine), or a combination of both. Referring to FIG. 2, when working with four inch presses starts with initialization but includes sending a token to the server 201, and the client retrieves user profile data from server 201. Thereafter, the client 202 auto-senses an HTML form by, for example, analyzing a content of the web page. Then client 202 retrieves an access entry from the server. Access may be based on the identification of that data item that, in case of an on-line form may be constructed, for instance, out of the page's URL, and form's name. Afterwards, client 202 restores the unique access entry key encryption key. The key may be generated as it was for this data item encryption, namely, a key base is created by applying a special operation (such as one-way hash function) to a combination of token key, PIN, and SKP that was retrieved from the server. Client 202 decrypts an access entry XML document and maps the XML document into an HTML form in the browser window.

Note that the wireless device in FIG. 2 may use and fill in WML forms as part of the process.

Note also that in case of a software token, the SDMU, token ID, and token key are located on the user's computer and are stored on that computer's hard drive. The token key may also be stored in an encrypted form with the encryption key derived, for instance, from the user's PIN, by applying a one-way has function to the PIN.

In one embodiment, the SDMU also monitors cookies created by the browser and treats cookies as a component of the online forms on the page. Thus, cookies are stored on the server and re-created when forms on a given page have to be filled in. This allows cookies to acquire mobility across different computers in that cookies created while browsing on one computer will be re-created and available for use on another computer. Recreating cookies on the fly may facilitate automatic login and navigation to the sites that require them.

In one embodiment, the system described herein solves PKI-related problems outlined above in the following way. Each set of PKI credentials comprising private key, public key and, optionally, a certificate, is treated as a separate sensitive data item. Its content is encrypted and stored on the server in the manner described above. A set of PKI credentials may be retrieved from the server on demand, its encryption key re-created and the credentials made available to a user (a human being or an application). Then, these credentials may be applied to creating or processing a secure transaction, (e.g., encrypting/decrypting and signing/verifying that transaction's content). The SDMU is enabled to perform special PKI-specific operations for this data type, including public/private key pair generation, and preparing and submitting a request for certificate creation.

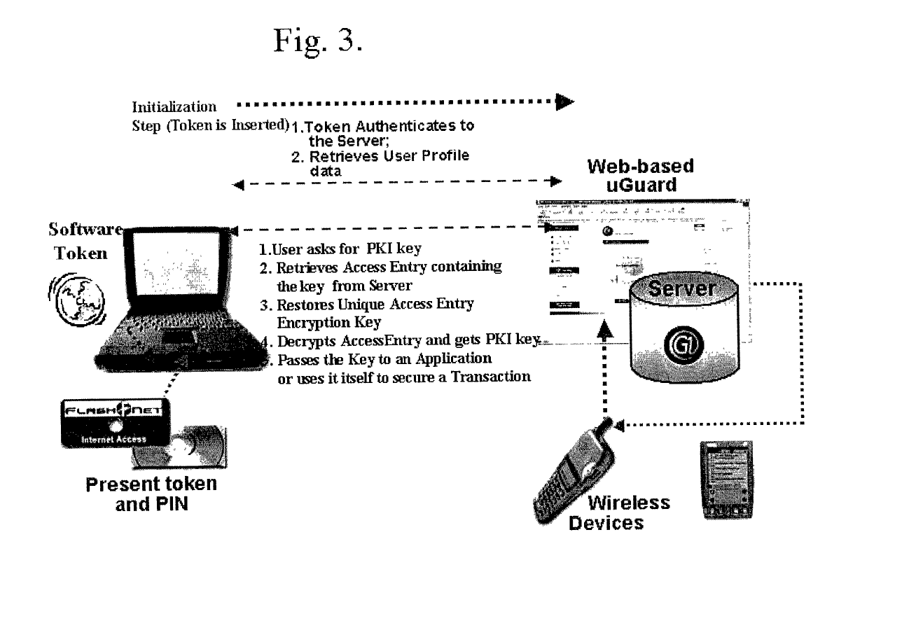

FIG. 3 illustrates one embodiment of a process of using PKI credentials. The process performed by processing logic that may comprise hardware (e.g., dedicated logic, circuitry, etc.), software (such as run on a general purpose computer system or a dedicated machine), or a combination of both. Referring to FIG. 3, process begins by the user asking for a PKI key. A user may ask for a PKI key by, for instance, choosing an appropriate data entry from the entries presented to him by SDMU. Next, processing logic retrieves an access entry containing the key from the server. Thereafter, processing logic restores the unique access entry encryption key, and decrypts the access entry to obtain the PKI key. Then, processing logic passes the key to an application and uses the key itself to secure a transaction.

In one embodiment, the SDMU may route a certificate creation request through the server that, in turn, submits it to a certificate authority designated by the service provider. In an alternate embodiment, the SDMU may route the request directly to a third-party certification authority.

In one embodiment, the SDMU may apply retrieved public/private keys to process the content of a file or to create a secure transaction from the content supplied by an application or human operator and submit this transaction to a recipient specified.

In one embodiment, management of PKI credentials, including distribution, revocation and renewal, may be done in the following manner. First, the server interfaces to PKI certification and/or registration authority facilities. When the PKI credentials of a user have to be renewed, the server is notified over this interface and the server sets a “renew PKI credentials” flag on the particular data entry storing that set of PKI credentials for the user. When the user accesses that set of PKI credentials, the SDMU is notified that the renewal flag has been set. The SDMU informs the user and automatically or semi-automatically (that is with user's confirmation) generates a new set of PKI credentials as described above. Thus, there is no need to generate and deliver a new set of credentials to a user before that user actually needs his credentials.

In the same manner, if a set of PKI credentials has to be revoked for the user, the “revoke” flag is set for the particular data entry storing that set of PKI credentials for the user. When the user accesses that set of PKI credentials, SDMU is notified that the revocation flag has been set. The SDMU informs the user and does not make the data available. The same mechanism is suitable for the initial PKI credentials distribution process.

In one embodiment, each set of PKI credentials is independent from the other, and a user may easily use as many different sets as necessary.

The same mechanism may be used to control initial distribution, renewal and revocation of other types of server-controlled resources.

In one embodiment, the SDMU and/or user may control what parts of PKI credentials to make available on the device. For instance, bringing a certificate down to a memory- and bandwidth-constrained wireless device may be not efficient or unfeasible at all. In that case, the following mechanism for signing transactions on a wireless device may be implemented. First, the certificate stored on the server as part of the data entry is not encrypted. Whenever a transaction initiated on the wireless device has to be signed with a private key from a particular set of PKI credentials, SDMU on the device access, the server and retrieves set of PKI credentials in a special mode. Namely, an encrypted private key and associated SKP are transmitted to the wireless device that re-creates the encryption key and decrypts the private key. The certificate is transmitted from the server only to the wireless gateway over the wired Internet. The wireless gateway caches the certificate. The device uses the private key to sign a transaction and sends this signed transaction to its destination. The transaction is routed through the same wireless gateway. When transaction reaches the wireless gateway, the certificate cached previously is attached to it, and the transaction is sent further over the wired Internet to its destination. Thus, the certificates are never transmitted over wireless network, and the private keys are never unencrypted with the exception of the wireless device belonging to the owner.

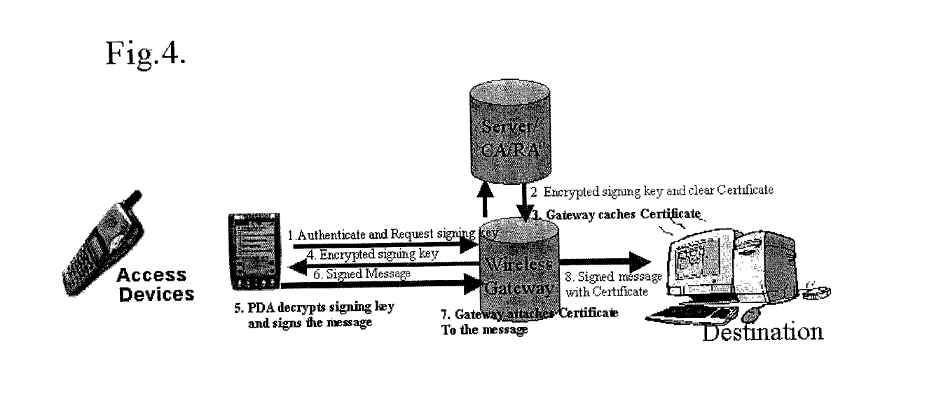

FIG. 4 illustrates the method described above for handling signed transactions on wireless devices.

In one embodiment, the server is implemented as follows. First, the SDMU connects to the server over the Internet using a secure connection method (e.g., SSL) and transmits a user's digital identity and token ID to the server. Then, the server verifies that the token with that token ID has not been reported as stolen or lost. If the token has been compromised, the server breaks the connection with the SDMU and records the IP address of the SDMU. This IP address may be used to track down the perpetrator. If the token's legitimacy has been confirmed, the server sends back to the SDMU a list of access entries for all previously accessed sensitive data items. The list is preferably encrypted by the SSL session key. Thereafter, the SDMU saves the list on the local computer. Afterwards, each time the SDMU accesses a particular data entry, it creates a usage entry that in one embodiment consists of an association <“Data entry identification”-“time stamp”>. Each time a new usage entry is generated, or periodically, all new usage entries are sent to the server. This advantageously allows the server to perform usage tracking. In an alternate embodiment, usage tracking information may include IP address of the SDMU. The server may be augmented with interfaces (such as the one with certificate authorities described above) to allow for setting special, data type-specific flags on data entries, thereby directing SDMU to undertake specific functions when SDMU accesses these data entries, or restricting access based on such parameters as IP address of the SDMU, date, time, usage statistics, access control verification performed by a third-party application, etc.

The architecture of one embodiment of the system lends itself to a combination with different vertical applications, such as e-wallets, web information aggregation services, PKI toolkits, online payment solutions. In one embodiment, the system may allow use of an API that allows for a “snap-in” integration with third-party solutions adding as the result highly secure and convenient way to handle the data these applications are concerned with.

If a user's token is stolen or otherwise compromised, he reports the fact to the server and the token (preferably its ID) is marked as compromised and its usage is locked. The token may also be locked if authentication fails a specific number of times in a row. In one embodiment, to unlock the token usage, a subscriber communicates with the service using an out-of-band procedure (such as calling in and proving his identity). That is, to prove his identity a user may be required, for instance to call customer support and answer some questions.

In one embodiment, (e.g., in case of a corporation implementing the system for its employees to access that company's secure resources), the server may choose to lock a token's use to a specified list of IP addresses. In that case, the server rejects the token if the IP address it's being used from does not match that list.

In one embodiment, the server may provide authorized personal with reports of the usage. In this case, the usage entries may be enhanced with required information (e.g., duration of access).

In one embodiment, tokens are initialized upon their first use, so that no out-of-band PINs distribution to the users is necessary. Tokens may be mailed to users, sold at the stores as pre-paid cards, etc. They acquire “digital identity” and get bound to a particular user only when the user invents a PIN upon the token's first use.

In one embodiment, if a user possesses multiple types of tokens (e.g., CD ROM, WAP Phone, Palm Pilot device, etc.), all tokens for that user are seeded with the same identity, thereby allowing that user to access and manipulate the same sensitive data independently on which token is being used at the moment.

In one embodiment, a service provider may require subscribers to check in (over the phone, for instance) before token activation. Then the service provider may tie that user's account with existing back-end systems. After this, the subscriber may start using the token. In one embodiment, upon first use, an initialization wizard starts automatically, asks the subscriber to devise the PIN, creates a digital identity of a token, and records it on the server.

In an alternate embodiment, a service provider may not require subscribers to check in before starting using the token. When the subscriber uses the token for the first time, the initialization wizard starts automatically, asks the subscriber to devise the PIN, creates a digital identity for the token, and records it on the server.

In one embodiment, a server-specific ID may also contribute to the digital identity of the user. In that case, a given user may have different digital identities when he accesses different servers using the same token and/or PIN. The subscriber may have to tell SDMU which server to converse with. Alternatively, the service provider may direct SDMU to switch its connection when a subscriber visits a particular web page on that provider's site.

In one embodiment, “general purpose” data is kept in one place—on the server operated by whoever issued tokens to a given subscriber. Individual providers may keep the data they want to control closely: PKI credentials, and encrypted cookies/usage scenarios for visiting protected pages belonging to this provider. Thus, a subscriber has a “primary” server operated by the provider that issued tokens to that subscriber and also is able to obtain other provider-specific data (such as PKI credentials) from servers operated by these individual providers. Each provider should be interested in issuing tokens because of the branding opportunities. At the same time, closely controlled data will be kept by each provider independently.

In one embodiment, the subscriber may have an option use the token without connection to the Internet, e.g. for accessing programs located on subscriber's computer such as accounting programs and the like. In such a case, if the SDMU detects that the Internet connection is not present, it creates and uses a local list of access entries. Security is not compromised, because access entries are useless without the token they have been created with.

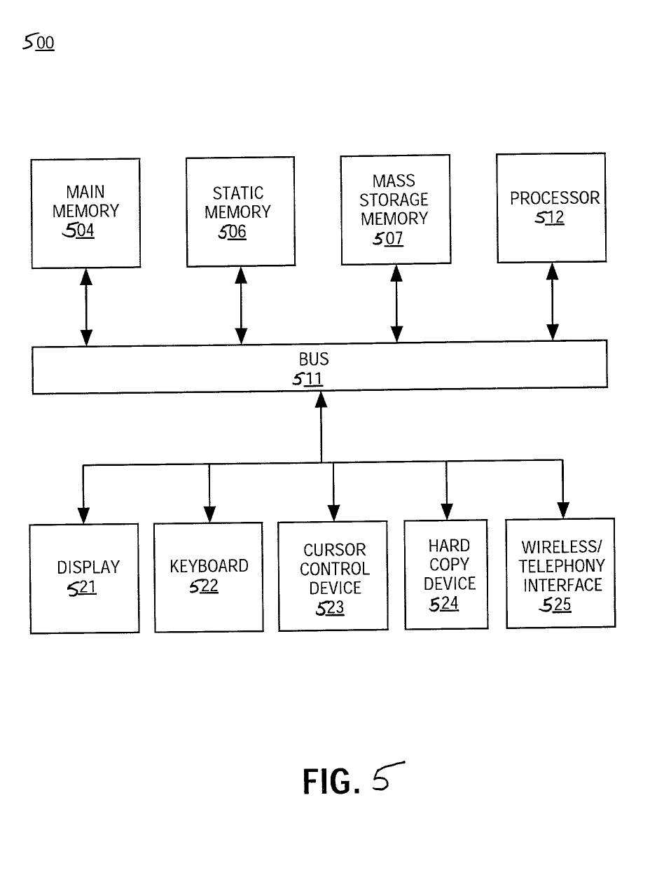

FIG. 5 is a block diagram of an exemplary computer system that may perform one or more of the operations described herein. Referring to FIG. 5, computer system 500 may comprise an exemplary client 550 or server 500 computer system. Computer system 500 comprises a communication mechanism or bus 511 for communicating information, and a processor 512 coupled with bus 511 for processing information. Processor 512 includes a microprocessor, but is not limited to a microprocessor, such as, for example, Pentium™, PowerPC™, Alpha™, etc.

System 500 further comprises a random access memory (RAM), or other dynamic storage device 504 (referred to as main memory) coupled to bus 511 for storing information and instructions to be executed by processor 512. Main memory 504 also may be used for storing temporary variables or other intermediate information during execution of instructions by processor 512.

Computer system 500 also comprises a read only memory (ROM) and/or other static storage device 506 coupled to bus 511 for storing static information and instructions for processor 512, and a data storage device 507, such as a magnetic disk or optical disk and its corresponding disk drive. Data storage device 507 is coupled to bus 511 for storing information and instructions.

Computer system 500 may further be coupled to a display device 521, such as a cathode ray tube (CRT) or liquid crystal display (LCD), coupled to bus 511 for displaying information to a computer user. An alphanumeric input device 522, including alphanumeric and other keys, may also be coupled to bus 511 for communicating information and command selections to processor 512. An additional user input device is cursor control 523, such as a mouse, trackball, trackpad, stylus, or cursor direction keys, coupled to bus 511 for communicating direction information and command selections to processor 512, and for controlling cursor movement on display 521.

Another device that may be coupled to bus 511 is hard copy device 524, which may be used for printing instructions, data, or other information on a medium such as paper, film, or similar types of media. Furthermore, a sound recording and playback device, such as a speaker and/or microphone may optionally be coupled to bus 511 for audio interfacing with computer system 500. Another device that may be coupled to bus 511 is a wired/wireless communication capability 525 to communication to a phone or handheld palm device.

Note that any or all of the components of system 500 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
generating a first key component;
generating an encryption key using the first key component, a token key and a personal identification number (PIN);
encrypting data using the encryption key;
sending the data encrypted with the encryption key to a server along with the first key component.

2. The method defined in claim 1 further comprising receiving the token key from a service provider.

3. The method defined in claim 1 further comprising the server storing the first key component and the data encrypted with the encryption key.

4. The method defined in claim 1 wherein the token key is unique for each user.

5. The method defined in claim 1 wherein the first key component is unique for each data entry stored by the server.

6. A method comprising:
encrypting data using the encryption key generating using a first key component, a token key and a personal identification number (PIN);
storing data encrypted using the encryption key; and
regenerating the encryption key after accessing the encrypted data to decrypt the encrypted data therewith.

7. The method defined in claim 6 further comprising disabling the token.

8. The method defined in claim 7 wherein the token is disabled if lost.

9. The method defined in claim 7 wherein the token is disabled if compromised.

10. The method defined in claim 7 further comprising re-enabling the token.

11. The method defined in claim 6 wherein the token ID comprises an alpha-numeric string.

12. The method defined in claim 11 wherein the token key comprises a randomly generated number.

13. The method defined in claim 11 wherein either or both of the token key and PIN comprises biometric data.

14. The method defined in claim 11 wherein the token key is the same for all tokens used by the user.

15. The method defined in claim 6 further comprising:
monitoring browsing activities;
identifying web pages containing a form; and
inserting content into the form.

16. The method defined in claim 15 wherein inserting content into the form is performed automatically.

17. The method defined in claim 15 wherein inserting content into the form is performed with user confirmation.

18. The method defined in claim 15 further comprising allowing a user to select the form to fill in.

19. The method defined in claim 15 further comprising allowing a user to select a variant of the form to fill in.

20. A method comprising:
retrieving a key component and encrypted data from a server;
recreating an encryption key using the key component, a token key and a personal identification number (PIN); and
performing a decryption operation on the encrypted data using a decryption key based on the encryption key used to encrypt the encrypted data.

21. A method for authentication comprising:
generating authentication data for a user based on a token key and a personal identification number (PIN), the token key being unique to the user; and
receiving a confirmation indicating that the authentication data has been verified.

22. A method comprising:
accessing encrypted data from a server;
decrypting the encrypted data using a token and a user-specific PIN to be accessed.

23. The method defined in claim 22 wherein the token comprises a token identifier (ID) and a token key.

24. The method defined in claim 22 wherein the token comprises a utility to manage data depending on data type.

25. The method defined in claim 24 wherein the utility operates on data in response to explicit user command or by automatically monitoring applications producing and/or consuming data of that type.

26. The method defined in claim 25 wherein the utility handles password data.
